(19) United States
(12) Patent Application Publication
(10) Pub. No.: US 2015/0343919 A1
(43) Pub. Date: Dec. 3, 2015

(54) VEHICLE-MOUNTED POWER SUPPLY DEVICE AND VEHICLE COMPRISING POWER SUPPLY DEVICE

(71) Applicant: SANYO Electric Co., Ltd., Osaka (JP)

(72) Inventors: HIDEKI SAKATA, Hyogo (JP); KAORU NAKAJIMA, Hyogo (JP); AKINOBU TSUNESADA, Hyogo (JP)

(21) Appl. No.: 14/435,602

(22) PCT Filed: Oct. 24, 2013
(86) PCT No.: PCT/JP2013/006302

§ 371 Date: Apr. 14, 2015

(30) Foreign Application Priority Data
Oct. 29, 2012 (JP) 2012-238125

(51) Int. Cl. B60L 11/18; H01M 10/625; H01M 10/6563; H01M 10/46

(52) U.S. Cl. CPC B60L 11/1877; H01M 10/46; H01M 10/625; H01M 10/6563; B60L 11/1816; H01M 2220/20

(57) ABSTRACT

A power supply device for a vehicle connectable in parallel to a lead-acid battery of 12 V, comprises a battery block including a plurality of secondary batteries capable of charging and discharging, a circuit board having an electric circuit configured to control the charging and discharging of the battery block, and a storage case for storing the battery block and the circuit board. The battery block is configured to connect an N number (N being a natural number) of nickel hydride batteries as the secondary batteries in series.

### TECHNICAL FIELD

The present invention is related to a vehicle-mounted power supply device and a vehicle comprising the power supply device, for example, a battery system for a vehicle where a lead-acid battery and a sub-battery are connected in parallel, and a vehicle incorporating this battery system.

### BACKGROUND ART

A conventional vehicle incorporates a lead-acid battery having a nominal voltage 12V of a lead-acid storage battery, and a large vehicle incorporates a battery having a nominal voltage 24 V where 2 pieces of the lead-acid batteries of 12 V are connected in series. The lead-acid battery is charged by an alternator of the vehicle, and supplies power to electric equipment devices or a starter motor. The lead-acid battery has a small discharging resistance, but has a large charging resistance, and then it is difficult to efficiently charge it. In order to improve this problem and enlarge the battery capacity (Ah) with respect to volume and weight, the battery system for a vehicle where the lead-acid battery and the lithium ion secondary battery are connected in parallel, is developed. (refer to patent literature 1)

### CITATION LIST

### Patent Literature

Patent Literature 1: Japanese Laid-Open Patent Publication No. 2007-46508

### SUMMARY OF THE INVENTION

However, as the voltage of the lithium ion secondary battery cell is normally 3.6 V, and even in the series connection, for example, it has 10.8 V of 3 series connection, 14.4 V of 4 series connection, and any one coincides with 12 V, and then it by itself cannot be connected to the lead-acid battery of 12 V. Therefore, a voltage converting circuit which increases or decreases the total voltage of the sub-battery including the lithium ion secondary batteries, is necessary, and it complicates a circuit, and it increases cost. In addition, a loss occurs by the voltage conversion, and such a loss is consumed as heat, and then the temperature of the sub-battery is increased. Especially, the battery generates heat by charging and discharging, and as the amount of current increases, the amount of heat generation also increases. The heat generation of the battery influences the adjacent electric circuit and also the life of the battery in itself. In order to stably use the sub-battery during a long time, it is desirable that heat radiation is improved. The heat loss is not preferable from the view point of heat radiation.

The present disclosure is developed for the purpose of solving such problem. One non-limiting and explanatory embodiment provides a power supply device for a vehicle and the vehicle incorporating the power supply device where it is connectable to a lead-acid battery without voltage converting.

A power supply device for a vehicle of the present disclosure connectable in parallel to a lead-acid battery of 12 V, comprises a battery block including a plurality of secondary batteries capable of charging and discharging, a circuit board having an electric circuit configured to control the charging and discharging of the battery block, and a storage case for storing the battery block and the circuit board, and the battery block is configured to connect an N number (N being a natural number) of nickel hydride batteries as the secondary batteries in series. Accordingly, by connecting the nickel hydride batteries of the nominal voltage 1.2 V in series, the required total voltage can be easily adjusted without voltage converting.

In the power supply device for a vehicle of the present disclosure, the battery block is configured to connect 10×n (n being a smaller natural number than N) pieces of the nickel hydride batteries in series. Accordingly, the total voltage of the battery block can be multiples of 12 V, and then the battery block can be connected in parallel to the lead-acid battery of 12 V or 24 V

In the power supply device for a vehicle of the present disclosure, the battery block is configured to connect 10 pieces of the nickel hydride batteries in series. Accordingly, the total voltage of the battery block is 12 V, and then it can be connected to the lead-acid battery of 12 V without voltage converting of increasing voltage or decreasing voltage.

In the power supply device for a vehicle of the present disclosure, a thermal insulation dividing wall divides the storage case into a storage space of the battery block and a storage space of the circuit board. Accordingly, the circuit board can be protected from heat generation of the battery block by the thermal insulation dividing wall.

In the power supply device for a vehicle of the present disclosure, a cooling air passage is formed to send a cooling air to a battery storage space divided by the dividing wall, and further an air passage opening is formed at the outer surface, and is connected to the cooling air passage with consecutive space. Accordingly, by the cooling air introduced from the air passage opening, the battery block disposed at the cooling air passage can efficiently radiate heat.

In the power supply device for a vehicle of the present disclosure, each of the nickel hydride batteries has a cylindrical outer case, and a covering portion having a curved surface along surfaces of the plurality of the cylindrical nickel hydride batteries is formed in the storage case. Accordingly, the secondary battery of the cylindrical shape has a large surface area to enhance heat radiation. Also the covering portion has the curved surface along the cylindrical shape, and then has a large surface area to enhance heat radiation in the same way.

In the power supply device for a vehicle of the present disclosure, each of the nickel hydride batteries is held in a horizontal posture in the storage case. Accordingly, even though water is stored by condensed water or the like in the storage case, short circuit of the positive and negative terminals of the total voltage can be prevented, and then safety can be enhanced.

In the power supply device for a vehicle of the present disclosure, the power supply device is capable of being installed in a vehicle having idling stop function, and both of the lead-acid battery and the power supply device are capable of being charged with power of regenerative power generation of the vehicle.

A vehicle having the power supply device of the present disclosure comprises an engine for driving, a radiator for cooling the engine for driving, and a cooling fan for forcibly blowing air to the radiator, and the cooling air passage is disposed in an air passage of the cooling fan.

A vehicle having the power supply device of the present disclosure comprises an engine for driving, and an alternator driven by the engine, or a regenerative braking of the vehicle, and the power supply device is charged by the alternator at the regenerative braking, and the vehicle has idle stop function.

In a vehicle having the power supply device of the present disclosure, the power supply device is disposed in an engine room.

### BRIEF DESCRIPTION OF DRAWINGS

FIG. 1 is a perspective view showing a power supply device related to one embodiment of the present invention.

FIG. 2 is an exploded perspective view of the power supply device of FIG. 1.

FIG. 3 is a vertical sectional view along a line III-Ill of the power supply device of FIG. 1.

FIG. 4 is a vertical sectional view along a line IV-IV of the power supply device of

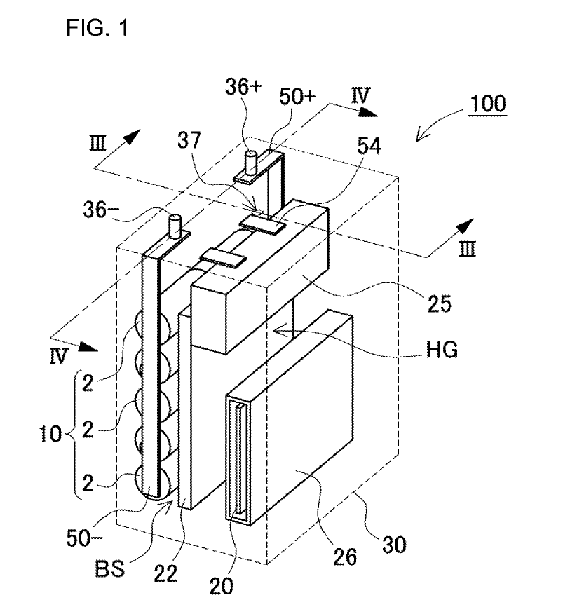

FIG. 1.

FIG. 5 is a perspective view showing a cooling air passage and an air passage opening of the power supply device of FIG. 1.

FIG. 6 is a schematic sectional view showing a cooling air passage of a power supply device related to a modified example.

FIG. 7 is a schematic view showing an example where the power supply device is set in an engine room of the vehicle.

FIG. 8 is a circuit diagram showing a state where the power supply device as the sub-battery and the lead-acid battery are connected in parallel.

FIG. 9 is a schematic sectional view showing a power supply device related to other modified example.

### DESCRIPTION OF EMBODIMENTS

Hereinafter, the embodiment of the present invention will be described referring to drawings. However, the following embodiments illustrate a power supply device for a vehicle and the vehicle having the power supply device which are aimed at embodying the technological concept of the present invention, and the present invention is not limited to the power supply device for a vehicle and the vehicle having the power supply device described below. In particular, as long as specific descriptions are not provided, it is not intended that the claims be limited to sizes, materials, shapes, and relative arrangements of constitutional members described in the embodiments, which are mere descriptive examples. It is noted that the magnitude or positional relation of the members illustrated in each diagram is sometimes grandiloquently represented, in order to clarify the description. Furthermore, in the description below, identical names and reference numbers represent identical or homogeneous members, and detailed descriptions are appropriately omitted. Moreover, mode may be applied where each element constituting the present invention constitutes a plurality of elements with the use of the same member, thereby serving the plurality of elements with the use of one member, or, in contrast, mode may be realized where a function of the one member is shared by a plurality of members. Also, a portion of examples and the content described in the embodiments can be applied to other examples and another embodiment.

### Embodiment 1

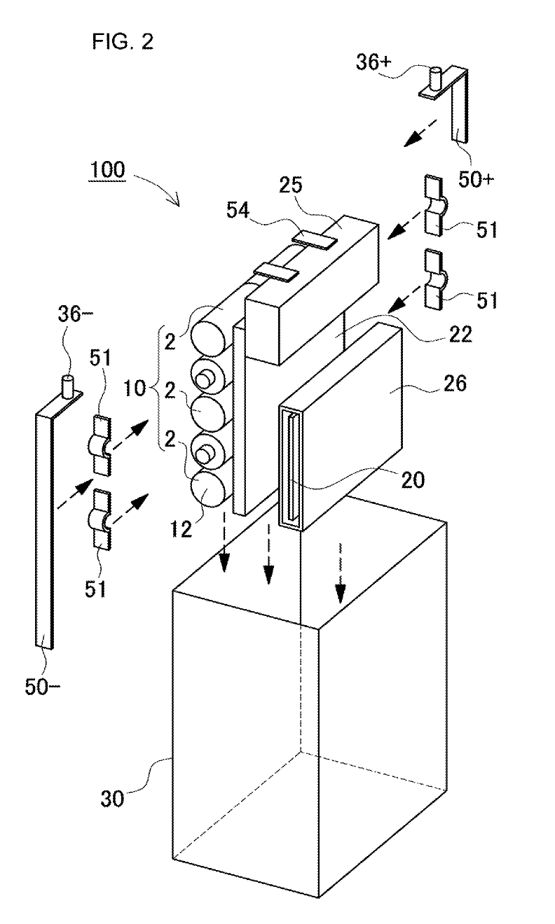

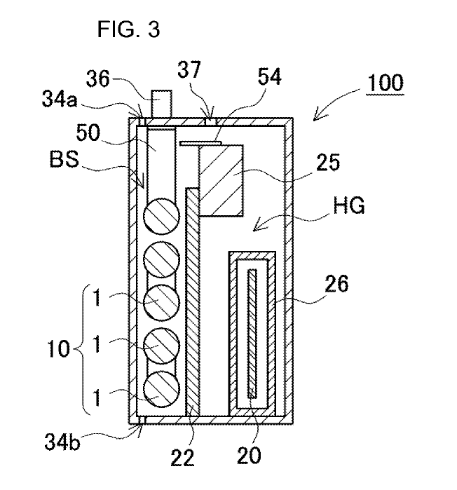

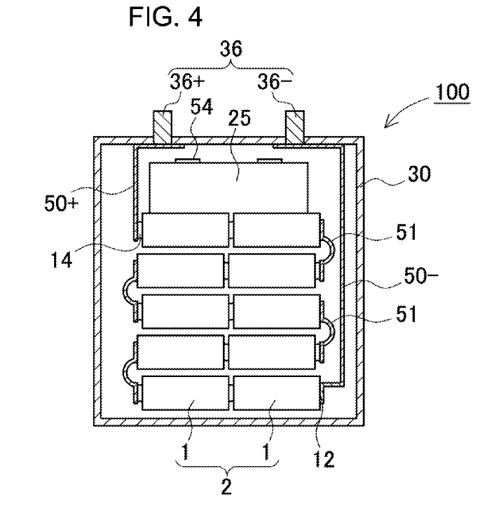

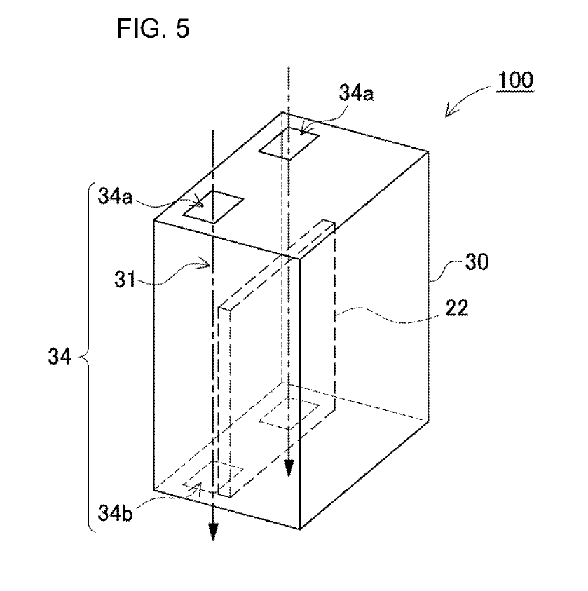

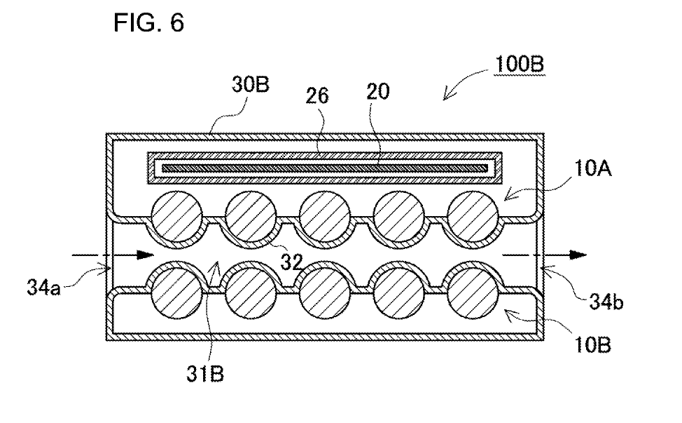

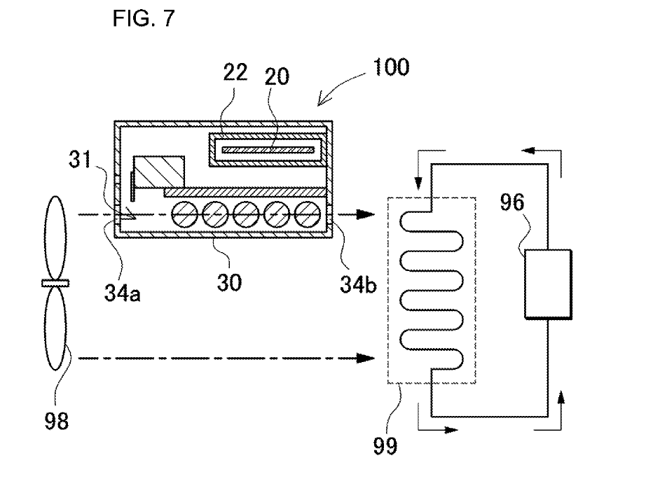

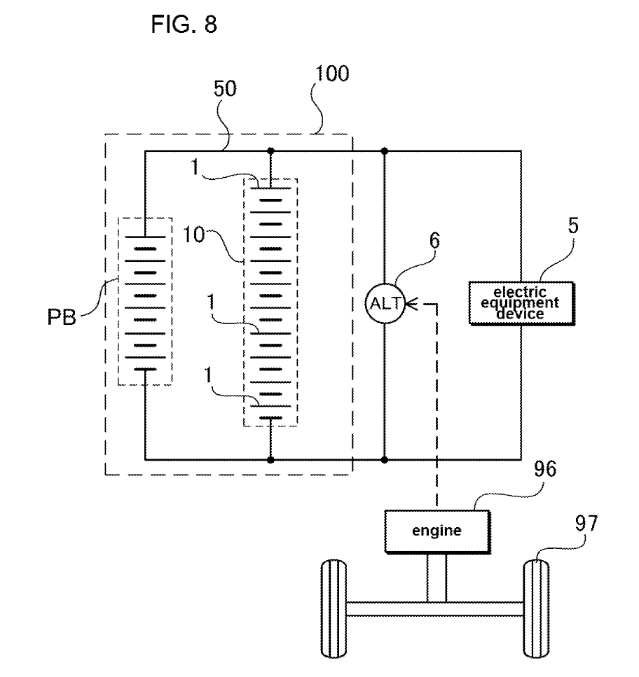

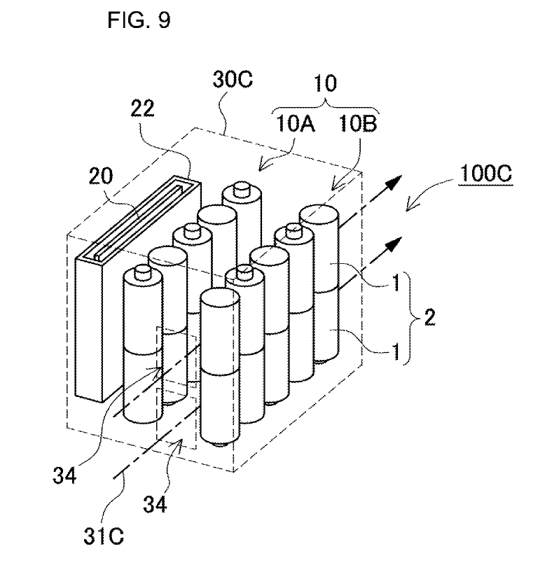

A perspective view showing a power supply device 100 related to one embodiment 1 of the present invention is shown in FIG. 1. An exploded perspective view of the power supply device 100 is shown in FIG. 2. The internal structure of the power supply device 100 is shown in sectional views of FIG. 3 and FIG. 4. The power supply device 100 shown in these figures has a battery block 10 including a plurality of secondary batteries 1, a circuit board 20 electrically connected to the battery block 10, a storage case 30 which stores the plurality of the secondary batteries 1 and the circuit board 20, and a pair of output terminals 36 which output total voltage of the battery block 10. In FIG. 1, the storage case 30 is shown in a dashed line in order to show the internal structure of the power supply device 100. The power supply device 100 for a vehicle as the sub-battery, as shown in FIG. 8 described below, is connected in parallel to the battery of 12 V for an electric equipment device like the lead-acid battery PB in this example.

### (Storage Case 30)

The storage case 30 has a rectangular shapes or a rectangular parallelepiped shape in the external appearance. The storage case 30 is preferably made of material excellent in insulation properties, for example, a resin. The plurality of the secondary batteries 1 and the circuit board 20 are stored in the storage case 30.

The pair of the output terminals 36 projects from the upper surface of the storage case 30. The output terminals 36 are configured to have a positive side output terminal 36+ connected to the positive side and a negative side output terminal 36− connected to the negative side in the total voltage of the battery block 10. Further, as shown in the vertical sectional view of FIG. 4, the positive side output terminal 36+ is connected to a positive side lead board 50+ and the negative side output terminal 36− is connected to a negative side lead board 50− in the storage case 30. Further, a bus bar 54 is provided at an upper portion in the storage case 30 in order to connect the battery block 10 described below and the switching portion 25 by wiring.

A gas exhaust hole 37 is opened at the upper surface of the storage case 30. In the case where the secondary battery 1 exhausts a gas, the gas is exhausted through the hole 37 in order not to excessively increase the pressure in the storage case 30. It is preferable that the gas exhaust hole 37 is coupled to a duct which safely exhausts the exhausted gas outside the vehicle.

The battery block 10 has a negative side connecting terminal 12 located at the lower surface side inside the storage case 30, and the positive side connecting terminal 14 located at the upper surface side inside the storage case 30. The positive side output terminal 36− is located at the upper surface side of the storage case 30, and is connected to the negative side connecting terminal 12 located at the lower surface side of the storage case 30 by a negative side lead board 50−. Further, the positive side output terminal 36+ is connected to the positive side connecting terminal 14 by the positive side lead board 50+. The positive side lead board 50+ is shorter than the negative side lead board 50−. In addition, the negative side connecting terminal 12 of the battery block 10 is grounded.

### (Secondary Battery 1)

The secondary battery 1 is capable of storing electric power, and the secondary battery cell can be suitably used. The nickel hydride battery can be suitably used as the secondary battery cell. Especially, as the power source voltage of the nickel hydride battery is 1.2 V, series connection of 10 pieces of the nickel hydride battery has 12 V, and is suitable for being connected to the lead-acid battery PB of the power source voltage of 12 V. In the example of FIG. 1, FIG. 2, and FIG. 4, 2 pieces of the secondary batteries 1 of the nickel hydride battery are connected in the elongated direction as one secondary battery group 2. The 5 pieces of the secondary groups 2 are arranged in parallel to each other in the same plane, and these configure the battery block 10. Namely, the battery block 10 comprises 10 pieces of the nickel hydride batteries. By adjusting a number of the series-connected batteries, the voltage of the power supply device 100 can be adjusted so as to coincide with that of the lead-acid battery to be connected. For example, for the lead-acid battery of a nominal voltage 24 V in a large vehicle such as a truck, by connecting 20 pieces of the secondary batteries 1 of the nickel hydride batteries in series, the voltage is corresponding to 24V. In addition, as necessary like 36V, or 48 V, the nickel hydride batteries are connected in series by 10 pieces, namely in 10×n (n being a natural number, × being a multiplication) pieces, and the output voltage can be adjusted to multiples of 12 V, and then the voltage is fitted for voltages of a lot of standardized power supply devices. Otherwise, an arbitrary N number (N being a larger natural number than n) of nickel hydride batteries are connected, and the total voltage of the battery block can be adjusted by 1.2 V. Further, the nickel hydride batteries may be connected in parallel, and by this the electric capacity of the power supply device can be increased.

Further, as the secondary battery group 2 is configured to connect 2 pieces of the secondary batteries 1 in the elongated direction, there is no secondary battery between the 2 pieces of the secondary batteries 1. As one end surface in each of the 2 pieces of the secondary batteries 1 faces outside without facing other secondary batteries, heat radiation from this end surface is obtained. In addition, heat radiation can be more improved such that this surface is disposed so as to face a side surface of the storage case 30.

In the example shown in FIG. 1 to FIG. 4, the secondary battery 1 uses a cylindrical outer can. The plurality of the cylindrical secondary batteries 1 are held in a horizontal posture, and are arranged planarly along the inner surface of the storage case 30. The battery block 10 is one row, and is disposed along one main surface (the main surface at the left side in FIG. 3) of the storage case 30, and this main surface can be used as the heat radiation surface of the secondary batteries 1. Further, the circuit board 20 is disposed at the other main surface (the main surface at the right side in FIG. 3), and then the circuit board 20 is located in spaced relationship with the batter block 10 as a heat generation source, and it can be reduced that heat generation of the secondary batteries 1 influence the circuit board 20.

Additionally, in a battery storage space BS where the battery block 10 is disposed in the storage case 30, as shown in FIG. 5, a cooling air passage 31s formed to send a cooling air. Further an air passage opening 34 is formed at the outer surface of the storage case 30, and is connected to the cooling air passage 31 with consecutive space. One side air passage openings 34a are intakes of the air passage opening 34, and the other side air passage openings 34b are exhaust outlets of a cooling air. These air passage openings 34a, 34b are opened at positions facing the cooling air passage 31 as shown in FIG. 5. By this structure, a cooling air guided from the air passage openings 34a is guided to the cooling air passage 31 linearly, and is exhausted through the other side air passage opening 34b. In other words, the structure can smoothly exchange heat between the cooling air introduced in the cooling air passage 31 and the secondary batteries 1 without the direction of movement of the cooling air bent in the storage case 30. Here, in FIG. 5, in order to show the cooling air passage 31 and the air passage openings 34b at the rear surface side so as to be easily understood, members such as the secondary batteries in the storage case 30 are omitted in the figure. Further, a flow of the cooling air is shown in an alternate long and short dash line.

In the above example, in the battery block, the secondary batteries are arranged in the same plane, but the secondary batteries can be arranged in plural layers. For example, as shown in the power supply device 100B of the schematic sectional view of FIG. 6, each of the battery blocks 10A, 10B comprises 5 pieces of the secondary battery group, and the battery blocks 10A, 10B may be stacked in the 2 layers and disposed in the storage case 30B. In this case, the cooling air passage 31B can be formed between the battery blocks. By this, the battery blocks 10A, 10B disposed at both sides of the one cooling air passage 31B, can be efficiently cooled simultaneously.

### (Covering Portion 32)

The secondary batteries are directly exposed in the cooling air passage. Other than this, as shown in FIG. 6, the surfaces of the outer cans of the secondary batteries 1 may be covered by covering portions 32. Especially, in the case of forming the cooling air passage, the airtight structure cannot be used in the storage case, and it is thought that dust or water drops intrude in the storage case. In order to protect the secondary batteries 1 against these, it is preferable that the surfaces of the secondary batteries facing the cooling air passage 31B are covered by the covering portion 32. By this, as the secondary battery has a cylindrical shape, its surface area is large and then heat radiation is enhanced. Additionally, the covering portions also have curved surfaces of the cylindrical shape along the cylindrical batteries, and then heat radiation area is enlarged in the same way and heat radiation can be improved.

The covering portion 32 covers the surfaces in the secondary batteries 1 facing the cooling air passage 31B. Namely, in the sectional view of FIG. 6, the surface in each of the first battery block and the second battery block is covered by the covering portion 32 so as to form the cooling air passage 31B between the upper first battery block 10A and the lower second battery block 10B. The covering portion 32 is made of insulation material, and the surfaces of the secondary batteries 1 are not directly exposed outside, and are covered by the covering portion 32. Additionally, the secondary batteries 1 can be protected from water drops or dust included by the cooling air. The covering portion 32 divides the inside of the storage case 30 into the battery storage space of the secondary batteries 1 and the cooling air passage 31B. In other words, the covering portion 32 is provided in the storage case 30 so as to demarcate the cooling air passage 31B. Preferably, the covering portion 32 is integrally formed with the storage case 30. Here, it is possible to form the covering portion as a separate part from the storage case. For example, a battery holder for holding the secondary batteries is formed, and a covering portion is provided in a part of the battery holder, and the battery holder is stored in the storage case as the double structure.

Further, it is preferable that a forcible cooling mechanism is provided so as to forcibly blow a cooling air in the cooling air passage. Such a forcible cooling mechanism is newly added, or the existing members are also used as the forcible cooling mechanism, and it is preferable form the view point in simplifying the structure or reducing the manufacturing cost. For example, in the power supply device for a vehicle, a cooling fan for a radiator can be used. An example where the power supply device is set in an engine room of the vehicle is shown in FIG. 7 of a schematic view. The vehicle in this figure comprise an engine 96, a radiator 99 for circulating a coolant to cool the engine 96, a cooling fan 98 for forcibly blowing air to the radiator. As shown in this figure, the power supply device 100 is disposed in an air passage of the cooling fan 98 for the radiator. In this case, the air passage opening portion is opened so as to cross the air passage, and the cooling air passage 31 is disposed so as to coincide with the blowing direction of the cooling air of the cooling fan 98, and then the cooling fan 98 is also used for cooling the secondary batteries of the power supply device. As the result, the existing equipment is used, and it is possible to efficiently cool the power supply device.

### (Circuit Board 20)

The circuit board 20 is disposed between the battery block 10 and the main surface of the storage case 30. This circuit board 20 includes an electric circuit for monitoring charging and discharging of the secondary batteries 1. Further, the circuit board 20 may include a safety protection circuit for cutting off a current when an abnormal state in each of the secondary batteries 1 is determined. Such an abnormal state in each of the secondary batteries 1 is monitored based on a current, a voltage, and a temperature.

The switching portion 25 is connected to the output of the battery block 10, and switches the ON/OFF of the output. In the example shown in the circuit diagram of FIG. 8 described below, in a state where the battery block 10 is connected in parallel to the lead-acid battery PB, the switching portion 25 is disposed between the battery block 10 and the lead-acid battery PB. In the case of turning on the switching portion 25, the battery block 10 is connected in parallel to the lead-acid battery PB. Further, in the case of turning off the switching portion 25, the battery block 10 is separated from the circuit. A relay or a semiconductor switching element can be used as the switching portion 25. This switching portion 25 is a heat generation member generating heat by an electric current passage.

### (Dividing Wall 22)

As shown in the sectional view of FIG. 3, a dividing wall 22 divides the inside of the storage case 30. The dividing wall 22 divides the storage case 30 into the battery storage space BS where the battery block 10 is disposed, and a heat insulation space HG where the circuit board 20 is disposed. The dividing wall 22 is made of a member having a thermal insulation. The dividing wall 22 of a thermal insulation physically separates the battery block 10 and the circuit board 20, and then suppresses that a heat generation of the secondary batteries 1 is conducted to the circuit board 20, and can protect the circuit board 20. The battery block 10 is disposed in the battery storage space BS. Further, the circuit board 20 and the switching portion 25 are disposed in the heat insulation space HG.

As shown in the sectional view of FIG. 3, it is preferable that the switching portion 25 is disposed at a higher position than the circuit board 20. By this, the heat generation of the switching portion 25 is conducted upward by natural convection, and then it is suppressed that the heat influences the circuit board 20 disposed at a lower position than the switching portion 25. Especially, the disposing example is not limited to the disposing example where the switching portion 25 is disposed right above the circuit board 20, and like the power supply device 100 shown in the sectional view of FIG. 3, it is preferable that the switching portion 25 and the circuit board are disposed in offset. In the example of FIG. 3, the circuit board 20 and the switching portion 25 are disposed in a diagonal line in the heat insulation space HG. By this disposition, the circuit board 20 and the switching portion 25 are disposed distantly in the restricted space, and further the influence by the heat generation from the switching portion 25 can be suppressed.

### (Circuit Surrounding Board 26)

The surroundings of the circuit board 20 can be covered. In the example of FIG. 1 to FIG. 3, the circuit board 20 and its surroundings are surrounded by a circuit surrounding board 26. The circuit surrounding board 26 is made of a member having a thermal insulation. The circuit surrounding board 26 of a thermal insulation physically separates the battery block 10 and the circuit board 20, and then suppresses that a heat generation of the secondary batteries 1 is conducted to the circuit board 20, and can protect the circuit board 20. Here, the circuit surrounding board 26 is omitted, and the dividing wall can be used so as to have the same effect as the circuit surrounding board 26. For example, the dividing wall is extended so as to divide the inside of the storage case completely, the circuit board is physically separated from the battery block 10, and then the dividing wall can protect the circuit board.

### (Laterally Disposed Posture)

As shown in the vertical sectional view of FIG. 4, in the battery block 10, each of the secondary batteries 1 is held in a laterally disposed posture. The laterally disposed posture means the direction parallel to the water surface in the case where water is stored in the storage case 30. Then in the vertical direction, namely in the direction perpendicular to the water surface, the battery block 10 is configured so as to stack the secondary battery groups 2. By this disposition, at the time of being covered with water, the number of the secondary batteries of which the terminals contacts water can be restricted. Namely, assuming that the secondary batteries are disposed at a vertically disposed posture in the storage case, the bottom surface in each of the secondary battery groups is located at the lower portion of the storage case. In this state, when the bottom portion (surface) of the storage case is covered with water by some reason, the terminal in each of the secondary battery groups is covered with water, and then there is a possibility that unintentional short circuit occurs.

On the contrast, in the present embodiment, as each of the secondary batteries is disposed in a laterally disposed posture, in the case where water is stored in the storage case 30, the number of the secondary batteries covered with water can be restricted in the minimum. Namely, as each of the secondary battery groups 2 constituting the battery block 10 is arranged in the vertical direction in a horizontal posture, only both ends of the secondary battery group located at the bottom surface are covered with water. In this state, even though a short circuit occurs, as the difference of the electric potentials is by 2 pieces of the secondary batteries, and for example, in the case of using the nickel hydride battery of 1.2 V, the difference of the electric potentials is 2.4 V, and then a short circuit current is small. Especially, in the case of the power supply device using the nickel hydride batteries, it is necessary that a gas exhausted from the nickel hydride battery at the time of over-charge is exhausted outside, and the gas exhaust hole is opened. Therefore, the storage case cannot use an airtight structure. As the result, it is difficult that intrusion of water into the storage case is stopped. However, as mentioned above, since each of the secondary batteries is disposed in a laterally disposed posture in the storage case having a hole for gas exhaust, damage by being covered with water is suppressed widely, and also the gas exhausted from the nickel hydride battery can be safely exhausted outside the storage case.

Further, the output terminals 36 are connected to the total voltage of the battery block 10, but as the secondary battery located at the bottom surface side is the negative side, safety can be improved. Namely, as the negative side is connected to the chassis ground, the difference of the electric potentials in the short circuit of this portion is smaller than that in the short circuit of the positive side.

### (First Lead Board 51)

In the secondary battery group 2 in each of the plural layers, the end edges of the secondary battery groups 3 vertically arranged are connected by first lead boards 51. The first lead boards 51 connect the secondary battery groups 2 to each other in the shortest distance. Such lead boards are made of a metal board having an excellent conductivity

The total voltage of the battery block 10 is outputted from the output terminals 36 through the positive side lead board 50+ and the negative side lead board 50−. In the example shown in the sectional view of FIG. 4, the positive side of the series-connected battery block 10 is connected to the positive side output terminal 36+ through the positive side lead board 50+, and the negative side of the series-connected battery block 10 is connected to the negative side output terminal 36− through the negative side lead board 50−. Here, in the end edges where the total output voltage is outputted, it is preferable that the lowest end edge is connected to the negative side lead board 50−. Namely, in the disposition of the secondary batteries shown in FIG. 4, in the end edge of the upper left and the end edge of the lower right of the battery block 10, the end edge of the lower right of the secondary battery is connected to the negative side lead board 50−, and the end edge of the upper left of the secondary battery is connected to the positive side lead board 50+. Thus, as the negative side total voltage is located at the lowest layer, in the case where a short circuit occurs by water covering, a large short circuit current can be prevented since the difference between the electric potentials is made small.

Even though the water level at which water intrudes in the storage case 30 is increased, only the number of the secondary battery group is increased corresponding to the increased water level. As long as the battery block 20 is not completely covered with water, short circuit by the total voltage does not occur. Thus, the merit that short circuit current is suppressed corresponding to the water level, is obtained.

As the positive side lead board 50+ is disposed at the highest layer, namely at the highest position of the battery block 10, even though water intrudes in the storage case 30, the possibility that short circuit occurs at this position is comparatively low, and then safety can be improved. Additionally, as the output terminals 36 are provided at the upper surface of the storage case 30, namely the highest position of the storage case 30, the possibility that the output terminals 36 are short-circuited, can be decreased in the same way. Similarly, the bus bars 54 are provided at the high position in the storage case 30, the risk that this portion is covered with water can be decreased, and then reliability and safety can be improved.

Moreover, the positive side total voltage is located at the highest layer of the battery block 10, the distance from the positive side output terminal 36+ is short, and then the length of the positive side lead board 50+ which connects these, can be short. Thus, as the exposed area of the positive side lead board 50+ becomes small, the risk that short circuit occurs can be decreased.

Here, in order to prevent the negative side lead board 50− from unintentionally contacting each of the first lead boards 51, it is desirable that an insulating member such as an insulating sheet is disposed between these first lead boards 51 and the negative side lead board 50−.

In the above example, the example where the secondary batteries are disposed in the horizontal posture in the storage case, is explained. However, the plurality of the cylindrical secondary batteries can be also held in a vertical posture in the storage case. The power supply device 100C related to such a modified example is shown in a perspective view of FIG. 9. The 2 rows of the battery block 10A, 10B are provided, and the battery block 10A, 10B are disposed in spaced relationship with each other along the facing main surfaces of the storage case 30C, and the space between them is a cooling air passage 31C. One of the 2 rows of the battery blocks 10 faces the inner surface in one of the main surfaces, and the circuit board 20 is disposed between the other battery block 10 and the inner surface in the other main surface. By this disposition, as the cooling air passage 31C is disposed in spaced relationship with the circuit board 20, the circuit board 20 does not prevent the cooled air from being introduced.

### (Circuit Diagram)

The example where the above power supply device 100 is connected to the battery system for a vehicle, is shown in FIG. 8. The vehicle shown in this figure moves with the engine 96 driving a wheel 97. The power supply device 100 is connected in parallel to the lead-acid battery PB. This power supply device 100 functions as the sub-battery to assist the lead-acid battery PB. The power supply device including the lead-acid battery PB and the sub-battery are directly connected with a lead wire without through a current adjusting circuit or the like. Therefore, the voltages of the lead-acid battery PB and the sub-battery are always the same voltage. Here, in the battery system of the present invention, the lead-acid battery and the sub-battery can be connected in parallel through a switching element such as a relay, or a semiconductor switching element, and can be connected in parallel through a diode.

The lead-acid battery PB has a nominal voltage 12 V by connecting 6 cells in series. Here, the present invention is not limited to the nominal voltage 12 V of the lead-acid battery. The nominal voltage 24 V is made by the series connection in 2 pieces of the lead-acid batteries, and the nominal voltage 36 V is made by the series connection in 3 pieces of the lead-acid batteries, and the nominal voltage 48 V is made by the series connection in 4 pieces of the lead-acid batteries. The conventional electric equipment is designed to operate at the power source voltage 12 V, and the vehicle incorporating the lead-acid battery 24 V to 48 V incorporates the electric equipment operating at this voltage.

The sub-battery connected in parallel can improve efficiency of charging and discharging, and can prevent degradation of the lead-acid battery. The sub-battery has the same voltage as the lead-acid battery by being connected in parallel to the lead-acid battery. In this state, current balance in charging and discharging between the sub-battery and the lead-acid battery PB, namely suitability is important. When the suitability is bad, only the lead-acid battery or only the sub-battery is charged, or only the lead-acid battery or the sub-battery is discharged. Thus, even though both are connected in parallel, efficiency of charging and discharging cannot be improved, or the life of the lead-acid battery cannot be effectively prolonged.

The suitability of the lead-acid battery PB and the sub-battery is realized to control characteristics of open-circuit voltage vs depth of discharge of the sub-battery. The characteristics of open-circuit voltage vs depth of discharge of the sub-battery is, for example, adjusted by the amount of zinc or the like added to the positive electrode in the nickel hydride battery.

The power supply device 100 is disposed vertically next to the lead-acid battery, and is stored in the engine room of the vehicle. As the power supply device 100 is used in the high temperature environment, in order to obtain high temperature durability, the electrolyte of the nickel hydride battery as the secondary battery 2, contains the at least one type of compound selected from a tungsten compound, a molybdenum compound, and a niobium compound. This configuration can provide the power supply device 100 which has durability in the case of installation in the engine room in addition to a high output (low resistance).

The above battery system can improve a fuel efficiency even in the vehicle where the alternator 6 driven by the engine 96 charges without regenerative braking. It is a reason why the power supply device 100 as the sub-battery can be charged with power at most 8 times more than that of the lead-acid battery PB. The alternator 6 of the vehicle charges the lead-acid battery with a constant voltage to prevent degradation, and in order to keep the supplied voltage to the electric equipment 5 to a constant value, the output voltage of the alternator 6 is stabilized to a constant voltage of about 14 V. Therefore, a current with which the alternator 6 charges the lead-acid battery PB is small, and the lead-acid battery PB is not charged with large current. Therefore, the alternator 6 of the output current 100 A is installed in the vehicle, but the alternator 6 do not charge the lead-acid battery with 100 A, and the alternator 6 supplies power to the electric equipment 5 with large current. As the alternator 6 charges the battery system with large current, a fuel efficiency of the vehicle can be improved. It is a reason why the alternator 6 is driven in the range of a high generation efficiency and also the engine 96 can be driven in the range of a low fuel consumption rate. The alternator 6 is low in a generation efficiency by a low load, and the engine 96 is high in a fuel consumption rate by a low load.

Further, the battery system for a vehicle using this power supply device 100 charges not only the lead-acid battery PB but also the power supply device 100 to protect the lead-acid battery PB from large current charging. In a state where the alternator 6 does not charge, not only the lead-acid battery PB but also the charged power supply device 100 supplies power to the electric equipment 5, and then the lead-acid battery is prevented from large current charge or over discharge, and the life can be prolonged.

### INDUSTRIAL APPLICABILITY

A power supply device for a vehicle and the vehicle having the power supply device related to the present invention can be suitably used a battery for an electric equipment in the vehicle or an auxiliary battery. Especially, in the vehicle which has an idling stop function to charge the lead-acid battery by regenerative braking, the load of the lead-acid battery can be reduced.

### REFERENCE MARKS IN THE DRAWINGS

100, 100B, 100C: power supply device
1: secondary battery
2: secondary battery group
5: electric equipment device
6: alternator
10, 10A, 10B: battery block
12: negative side connecting terminal
14: positive side connecting terminal
20: circuit board
22: dividing wall
25: switching portion
26: circuit surrounding board
30, 30B, 30C: storage case
31, 31B, 31C: cooling air passage
32: covering portion
34, 34a, 34b: air passage opening portion
36: output terminal 36+: positive side output terminal 36−: negative side output terminal
37: gas exhaust hole
50: lead wire
50+: positive side lead board
50−: negative side lead board
51: first lead board
54: bus bar
96: engine
97: wheel
98: cooling fan
99: radiator
PB: lead-acid battery
HG: heat insulation space
BS: battery storage space

1. A power supply device for a vehicle connectable in parallel to a lead-acid battery of 12 V, comprising:
a battery block including a plurality of secondary batteries capable of charging and discharging;
a circuit board having an electric circuit configured to control the charging and discharging of the battery block; and
a storage case for storing the battery block and the circuit board,
wherein the battery block is configured to connect an N number (N being a natural number) of nickel hydride batteries as the secondary batteries in series.

2. The power supply device for a vehicle according to claim 1,
wherein the battery block is configured to connect 10×n (n being a smaller natural number than N) pieces of the nickel hydride batteries in series.

3. The power supply device for a vehicle according to claim 2,
wherein the battery block is configured to connect 10 pieces of the nickel hydride batteries in series.

4. The power supply device for a vehicle according to claim 1,
wherein a thermal insulation dividing wall divides the storage case into a storage space of the battery block and a storage space of the circuit board.

5. The power supply device for a vehicle according to claim 4,
wherein a cooling air passage is formed to send a cooling air to a battery storage space divided by the dividing wall, and
further an air passage opening is formed at the outer surface, and is connected to the cooling air passage with consecutive space.

6. The power supply device for a vehicle according to claim 1,
wherein each of the nickel hydride batteries has a cylindrical outer case, and a covering portion having a curved surface along surfaces of the plurality of the cylindrical nickel hydride batteries is formed in the storage case.

7. The power supply device for a vehicle according to any claim 1,
wherein each of the nickel hydride batteries is held in a horizontal posture in the storage case.

8. The power supply device for a vehicle according to claim 1,
wherein the power supply device is capable of being installed in a vehicle having idling stop function, and both of the lead-acid battery and the power supply device are capable of being charged with power of regenerative power generation of the vehicle.

9. A vehicle having the power supply device according to claim 5, comprising:
an engine for driving;
a radiator for cooling the engine for driving; and
a cooling fan for forcibly blowing air to the radiator,
wherein the cooling air passage is disposed in an air passage of the cooling fan.

10. A vehicle having the power supply device according to claim 1, comprising:
an engine for driving; and
an alternator driven by the engine, or a regenerative braking of the vehicle,
wherein the power supply device is charged by the alternator at the regenerative braking, and the vehicle has idle stop function.

11. A vehicle having the power supply device according to claim 1,
wherein the power supply device is disposed in an engine room.
